(19) United States
(12) Patent Application Publication
(10) Pub. No.: US 2010/0068119 A1
(43) Pub. Date: Mar. 18, 2010

(54) Process for Production of Hydrogen and Carbon Dioxide Capture

(76) Inventor: Calvin Billings, Lake Charles, LA (US)

Correspondence Address: Douglas Baldwin, P.O. Box 485, Wellborn, TX, 77881, US

(21) Appl. No.: 12/623,399

(22) Filed: Nov. 21, 2009

Related U.S. Application Data
(63) Continuation of application No. 12/283,862, filed on Sep. 16, 2008.

(51) Int. Cl. C01F 5/24; C01B 3/36

(52) U.S. Cl. 423/430; 252/373

(57) ABSTRACT

A process for removing CO₂ from a gas containing CO₂ by reacting it with a magnesium silicate mineral suspended in a molten salt and additionally a process for converting coal or other fossil fuel to hydrogen by reaction the fossil fuel or coal with water in a molten salt at elevated temperatures in the presence of a magnesium silicate mineral suspended in the molten salt wherein the magnesium silicate reacts with CO₂ produced in the reaction, thus removing it from the hydrogen product gas.

### CROSS REFERENCE TO RELATED APPLICATIONS

This application is a Continuation-In-Part of a U.S. Application; Ser. No. 12/283,862 filed Sep. 16, 2008 and claims the benefit of U.S. Provisional Application, No. 60/994,182, filed Sep. 18, 2007.

### FIELD OF THE INVENTION

This invention relates to the capture of carbon dioxide by reacting it with a magnesium silicate mineral suspended in a molten salt and a process for the production of hydrogen from coal and all other carbon containing fossil fuels. More specifically, the hydrogen production aspect of this invention relates to a process of gasification of fossil fuels in a molten salt reactor followed by conversion of carbon monoxide to carbon dioxide and sequestration of the carbon dioxide with a magnesium silicate mineral suspended in the molten salt.

### BACKGROUND

There is a growing demand for hydrogen for use as a clean fuel for many applications as well as for fuel in fuel cells. Coal and other fossil fuels are an abundant source of carbon that when reacted with oxygen and water produces hydrogen. Thus, gasification of coal is a logical source for the production of hydrogen. The purpose for doing so is to remove the carbon from the fuel so that it can be sequestered and not released to the atmosphere when burned. For example, there has been a recent breakthrough in producing natural gas from shale formations, adding substantially to reserves with a subsequent reduction in price. If it is continued to be used for fuel the carbon dioxide released will contribute to global warming. If the natural gas is converted to hydrogen by the method of this invention the carbon dioxide (CO₂) can be sequestered. Reference herein to coal gasification is to be understood to also refer to any fossil fuel where the carbon is converted to CO₂ and sequestered.

Gasifying coal is a 125 year old technology. If coal and steam are combined at about 1600° F. they react to form hydrogen and carbon monoxide (syngas). Depending on the coal type and the gasifier design, other products are present in the syngas, such as nitrogen, carbon dioxide, hydrogen sulfide, nitrogen oxides and mercury.

Carbon monoxide (CO) produced by gasification can be converted to carbon dioxide by the so called “water gas shift” reaction in which water and carbon monoxide are reacted to produce carbon dioxide and hydrogen. Many processes have been proposed for these purposes. However, a truly economical process is needed. The process must be simple in order to make it economical. If the syngas product is too expensive because the process and equipment are too elaborate then it will not be commercially viable.

The importance of reducing carbon dioxide emmissions is illustrated by the U.S. Government sponsored $1.5 billion FutureGen project in Illinois that will demonstrate coal gasification with nearly complete carbon dioxide capture—with the carbon dioxide being injected into underground domes. The US Department of Energy has reported that the amount of CO₂ produced from the combustion of fossil fuels in the United States will reach nearly 5.7 billion metric tons in 2009 with about 33% coming from the coal-fired electric power sector.

Among the many proposed schemes for CO₂ capture is the use of abundant naturally occurring magnesium silicate minerals, particularity Olivine. Magnesium silicate reacts with CO₂ to form MgCO₃ a stable, nontoxic mineral that is may be easily disposed. The difficulty is that the reaction rate of magnesium silicate and CO₂ is slow. O'Conner, et al have reported on the process of reacting Olivine with high pressure CO₂ aqueous solution. O'Connor, W. K.; Dahlin, D. C.; Nilsen, D. N.; Rush, G. E.; Walters, R. P. & Turner, P. C. (2001b) Carbon dioxide sequestration by direct mineral carbonation: results from recent studies and current status. Zevenhoven and Kohlmann have proposed increasing the reaction rate by microwaving the Olivine; Ron Zevenhoven and Jens Kohlmann; CO₂ SEQUESTRATION BY MAGNESIUM SILICATE MINERAL CARBONATION IN FINLAND; Second Nordic Mini-symposium on Carbon Dioxide Capture and Storage, Göteborg, Oct. 26, 2001, available at http://www.entek.chalmers.se/˜anly/symp/symp2001.html. According to R. D. Olaf Schuiling, Professor in Geochemistry, at the University of Utrecht, weathering (reacting with CO₂) of Olivine and other magnesium silicate minerals is a possible solution for removing CO₂ from the atmosphere—the abundant mineral would be finely ground and spread out over the surface of the earth and eventually atmospheric CO₂ would react with it to produce magnesium carbonate.

None of these proposals appear commercially practical for in-situ CO₂ capture from a gas stream, such as from flue gases, synthesis gas, natural gas or the like.

The present invention provides a solution by reacting CO₂ in gas streams with magnesium silicate suspended in a molten salt. Coupled with gasification of fossil fuels in the same molten salt results in a superior integrated fossil fuel gasification process that eliminates CO2 emissions.

### SUMMARY OF THE INVENTION

The process of this invention is in one aspect a low cost, coal gasification/water gas shift process that captures and sequesters CO₂ in a rock mineral. The reactions are conducted in one reactor vessel having a tubular pre-reactor, from which the effluent products and reactants are further converted in a molten salt pool. The molten salt catalyzes the reactions and captures the undesirable contaminants so that further gas cleaning is not required. Carbon dioxide is optionally removed by sequestration with a magnesium silicate rock mineral, such as Olivine or Serpentine. In some instances there may be a use for the carbon dioxide or mixed flue gas for injection into oil formations for enhanced recovery. In this situation magnesium mineral will not be added to the bath to form magnesium carbonate. To capture sulfur compounds, calcium oxide or fly ash can be added to the bath to form calcium sulfide. The solid CaO is converted to CaSO₄ and withdrawn from the reactor system with the ash.

The salt bath is such an excellent catalytic and heat transfer medium that it is technically possible to achieve some degree of reaction without using a pre-reactor and simply pumping the reactants into the bath. However, the pre-reactor has proven much more effective, especially in providing reaction temperature to the bath.

In one embodiment, this invention is a process for producing hydrogen from a carbon containing fossil fuel comprising; contacting carbon-containing fossil fuel, water and oxygen in a pre-reactor at an elevated temperature, to convert some of the carbon in the fossil fuel to hydrogen and carbon monoxide;

discharging effluent gas and solids from the pre-reactor below the surface of a molten salt pool under such conditions of residence time and temperature that carbon from the fossil fuel in the pre-reactor effluent is converted to hydrogen and carbon monoxide, and the carbon monoxide is converted to carbon dioxide, which, in turn, is reacted with magnesium silicate contained in the molten salt pool, and;
recovering hydrogen from the molten salt pool.

Excess water causes the CO to form CO₂ and H₂. Magnesium silicate, such as olivine, added to the salt bath reacts with the CO₂ to form MgCO₃. The only gas to leave the reactor is H₂ and N₂ (if air is the oxidant) and water vapor. All other compounds stay in the salt bath and are continuously drawn off in a purge cycle for recovery and recycle of the salt. In one embodiment where it is desirable to recover the carbon dioxide for other uses the magnesium silicate is eliminated and the produced gas will contain both hydrogen and carbon dioxide.

In another aspect the process of the invention is a process for capture of carbon dioxide from a gas by reaction of the carbon dioxide with magnesium silicate mineral suspended in a molten salt. While the gasification reaction is preferable carried out at a temperature range of about 1500° F. and about 2000° F. the carbon dioxide capture reaction may be carried out at about at a temperature range of 350 to 2000° F.

### DESCRIPTION OF THE DRAWINGS

FIG. 1 is a schematic diagram of the reactor and the process of the invention.

FIG. 2 is a schematic drawing of a gasification reactor of one embodiment of this invention.

FIG. 3 is schematic drawing of a carbon dioxide capture embodiment of the invention.

### DESCRIPTION OF PREFERRED EMBODIMENTS

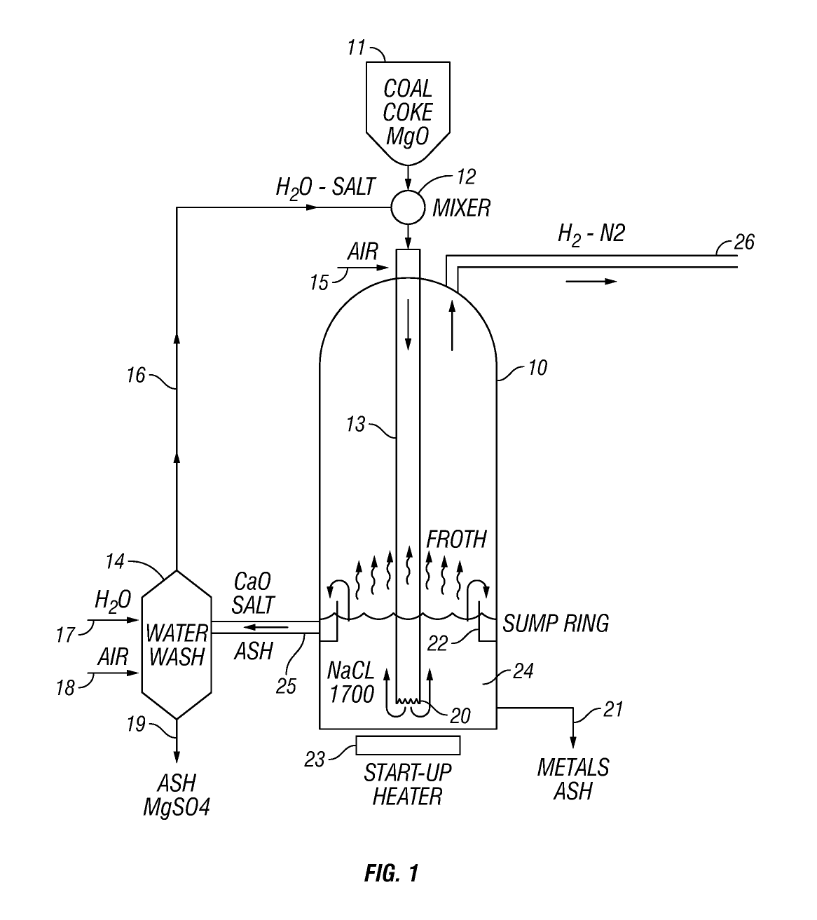

In one aspect the process of the invention uses one reaction vessel, illustrated in FIG. 1. The reactor vessel comprises a vessel, 10, containing a pool of molten salt, 24, and a pre-reactor reaction tube, 13, extending from the inlet of the molten salt vessel into the pool of molten salt 24. Reactants are mixed in mixer 12 and fed into the pre-reactor tube, 13, where they are, at least, partially reacted. These partially reacted products are discharged, 20, into a pool of molten salt, 24, and the resulting reaction products are removed by way of outlet, 26.

Fossil fuel (coal, coke and various grades of petroleum or natural gas) and olivine are stored in a hopper 11 for feeding into the gasification reactor 10. These are mixed with water and recycle salt in mixer 12 and injected into pre-reactor 13 together with air (15) or oxygen. Reactor vessel 10 has an internal sump ring 22 for withdrawal of a salt/ash mixture from the reactor by way of a slip stream through conduit 25. This withdrawn mixture is washed in vessel 14 and the resulting washed salt is recycled to the reactor pre-reactor tube.

Startup heater 23 is provided to melt and preheat the salt at startup. Hydrogen product exits the reactor 10 by conduit 26. The reactor vessel is also provided with a means, 21, to draw off salt and contaminants at the bottom of the reactor vessel.

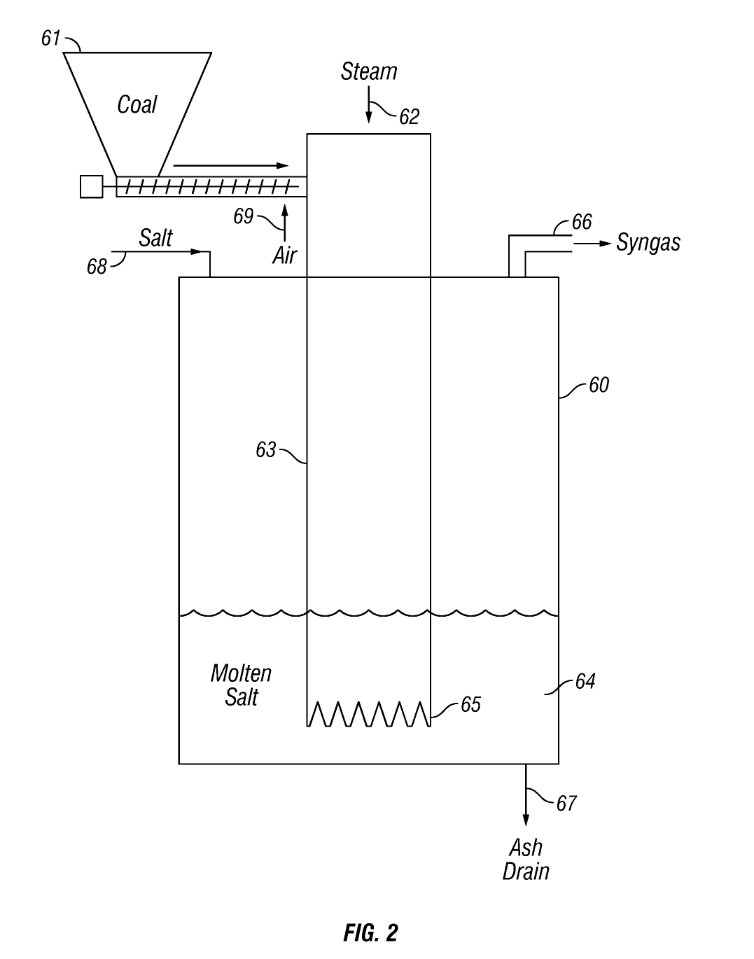

FIG. 2 shows some important features of the reactor system in more detail. The reactor vessel (60) is the reactor vessel corresponding to vessel 10 in FIG. 1, having molten salt (64) and a pre-reactor tube 63. Coal and magnesium silicate from hopper 61 are mixed with oxygen (or air) (69) and fed into the pre-reactor. Make-up salt in added at 68. The product hydrogen (and nitrogen, if air is used) is withdrawn at 66 and ash and metals are withdrawn at 67. A key feature of the pre-reactor tube, in one embodiment, is a series of V notches (65) cut around the circumference of the bottom outlet as illustrated in FIG. 2. These notches allow the gas to emerge out in a continuous small stream. Without them the gas tends to emerge in surges that form large bubbles and prevent good intermix of the gas and salt. Other means of dispersing the effluent gas such as a screen, holes around the circumference, etc may also be used effectively, however the notches have performed well.

While the reactor may operate from atmospheric pressure to about 150 atmospheres, it is preferred that the operating pressure be maintained at about atmospheric up to about four atmospheres and more preferably at up to about two atmospheres pressure. The process performs best at these lower pressures and such eliminates the need for costly high pressure compression of the inlet gases. The construction and materials for the reactor vessel and other components of the system are selected to accommodate the operating temperatures and pressure.

It has been determined that an effective ratio of feed to salt is between 1 part feed per hour to 10-100 parts salt, and more preferably about 1-15. The preferred feed to water ratio is 1 part feed to 1-5 parts water, and more particularly 1-2. The preferred percentage of magnesium silicate in the reactor is between 5-20 percent of the salt content, and more preferably about 8 percent.

### The Gasification Process

Referring to the reactor system in FIG. 1, the salt first has to be brought to operating temperature (1500° F. to 2000° F.) using external heater 23. Once the salt is melted the hot effluent from the pre-reactor (13) sustains the salt temperature. Powdered coal/coke or a mixture thereof is stored in bin 11 (FIG. 1). Additionally, about 8% olivine is mixed in with the coal to capture sulfur and CO₂ released in the reaction. Water is fed with the coal mix into a mixer 12 to create a slurry that is sprayed into the pre-reactor tube 13. Air or oxygen is fed in separately by conduit 15 into the top of pre-reactor tube 13. The coal is ignited and about 20% (in one embodiment) is burned to provide heat for the reaction, C+H₂O→H₂+CO. This reaction occurs in the pre-reactor tube. The temperature will be from about 1500° F. to 2000F, with 1700° F. to 1800° F. being preferred. The gas travels down the pre-reactor tube and emerges below the surface of the molten salt bath (20) where any un-reacted carbon is converted. Sulfur in the coal is converted to hydrogen sulfide in the pre-reactor tube and further reacts in the molten salt bath to form a metal sulfide. Mercury is also absorbed by the salt bath and ammonia and nitrous oxides are reduced to their basic elements. Ash is physically washed out of the gas stream and accumulates in the bath. Chlorine is retained as a metal chloride. As these various compounds accumulate in the bath they have to be purged in continuous bleed slip streams 25 and 21 and fresh salt such as sodium chloride is added to keep the salt active and fluid (preferable by recycle of salt washed from the ash/salt bleed stream 16). Ash in the coal is physically washed out of the gas by the liquid salt. As the gas flows through and out of the salt it forms froth on the surface that is an excellent contact medium to clean the gas of all particulates, sulfur, mercury and nitrogen compounds. Inside the reaction vessel is a sump ring 22 that collects excess salt and ash as it builds up. The froth action spills over into the sump ring and the salt and ash are drained off, 25, into water wash unit 14. Here the mixture is washed with water to remove the salt from the solids. The salt is recycled and the solids discarded. Salt water from the washing is recycled (16) back to the top to make a slurry with the coal feed.

There is provided a drain from the bottom of reaction vessel (21) to remove metals that are too heavy to come out with the ash.

If it is undesirable to have nitrogen in the product hydrogen gas, the gasification in the reaction vessel may be carried out without oxygen. In this embodiment of the invention, carbon (from) coal will react with steam (water) to form syngas. When oxygen is used, the required heat is generated by the reaction of oxygen and coal. When oxygen is not used heat must be supplied. While the reaction of CO₂ with magnesium silicate produces some heat it is insufficient alone to maintain the temperature of the salt. This may be accomplished by indirect heating of the pre-reactor tube, as by providing an annular space around the tube and firing it with fuel and oxygen the product hydrogen may be used as fuel, if desired.

As CO begins to form from the gasification reaction (C+H₂O→CO+H₂) the addition of extra water forms CO₂ (C+2H₂O→CO₂+2H₂) and additional H₂, the water gas shift reaction (WGS). When the CO₂ contacts magnesium silicate in the salt pool it is converted to MgCO₃, effectively removing CO₂ from the gas stream, enabling the WGS reaction to proceed faster. Gas leaving the top of the reactor is H₂ (and N₂ if air is used) and water vapor.

In the reaction vessel the molten salt level will be about 15 to 45 percent of the total height of the vessel with about ⅓ the height being especially preferred.

Many salts can be used in the syngas and carbon dioxide capture reaction vessel, but the most economical is sodium chloride. Its availability is virtually unlimited and disposal is benign. In one embodiment it is preferred to use lower melting salts for carbon dioxide capture, including eutectic mixtures with melting points of about 250 to 600° F. Suitable salts include metal chlorides, carbonates, sulfates, sulfites, nitrates, nitrites, bromides, oxides, hydroxides, per chlorates and mixtures thereof. Pollutants entering the salt from the inlet gases and fossil fuel that accumulate in the salt must be purged from the system to keep the salt active and fluid. A constant bleed of the salt bath and a constant re-supply of salt must occur. A percentage of the purge stream will be sodium chloride (or other salt used in the molten salt bath). It can be recovered by water wash and recycling the water or it can be disposed of. The point is, due to the huge volume of salt involved it desirable that it be the most abundant and cheapest available, that is, sodium chloride. Several magnesium silicate minerals are suitable for use in reacting with the CO₂, including serpentine [Mg₃(Si₂O₅)(OH)₄], enstatite (MgSiO₃), and olivine, which actually represents a mineral group encompassing the solid-solution series between magnesium-rich (forsterite, Mg₂SiO₄) and iron-rich (fayalite, Fe₂SiO₄). Wollastonite 9CaSiO₂) is also suitable. Mineral as used herein means a naturally occurring solid formed through geological processes that has a characteristic chemical composition, a highly ordered atomic structure, and specific physical properties. In some aspects fly-ash can also be used but is generally less effective.

The process is capable of gasification of all grades of coal, petroleum coke, petroleum and natural gas, with capture and disposal of inherent pollutants, including CO₂. Only hydrogen and nitrogen are produced in one embodiment of the invention.

During the in-reactor removal of CO₂, there is produced a residue of reacted magnesium silicate product and other solids. This residue and ash can be used as landfill, and possibly for road and building material.

Waste water is recycled through the system and/or used for boiler water makeup, etc.

### Carbon Capture Process

While the gasification process with in situ carbon dioxide capture is an important aspect of the present invention, the ability to capture carbon dioxide from any gas stream is an equally important aspect. While there has been, and continue to be, many attempts to accelerate the reaction rate of the CO₂/magnesium silicate reaction no one has yet found a suitable solution—the reaction rate is simply too slow in all the studies to date. Suspending the magnesium silicate in molten salt provides a solution.

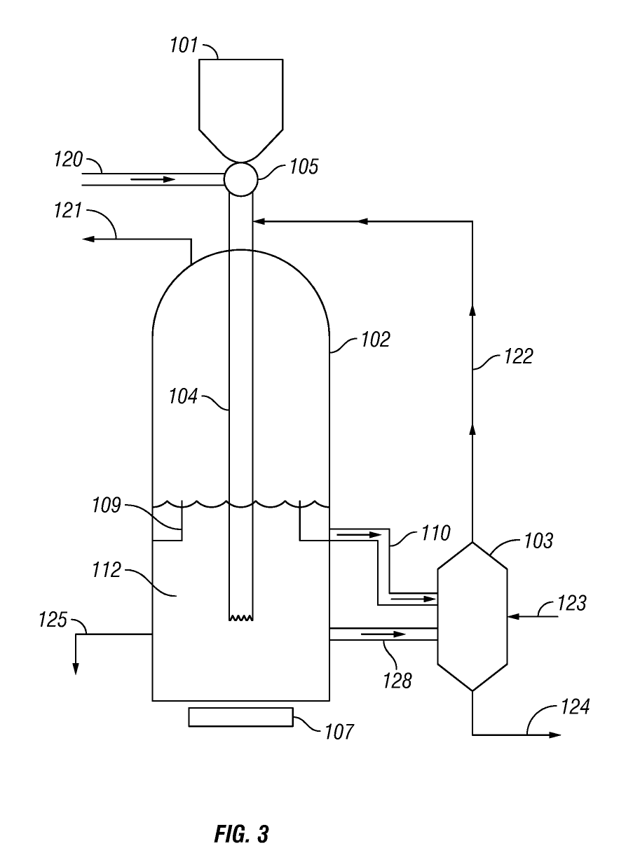

The process for capture of CO₂ from a gas stream is described by reference to FIG. 3.

A high temperature embodiment is shown by referring to reactor vessel 102 in FIG. 3, salt in the reactor vessel is brought to operating temperature (1500° F. to 2000° F. with about 1700° F. to 1800° F. being preferred) using external heater 107. Once melted the salt temperature is maintained by the heat of reaction from the exothermic reaction of magnesium silicate with CO₂ to form magnesium carbonate (MgCO₃). The molten salt level will, as in gasification, be about 15 to 45 percent of the total height of the vessel with about ⅓ the height being especially preferred. In another embodiment lower melting eutectic salt mixtures are used. A zinc chloride/potassium chloride mixture will have a melting point of about 200° F. and may suitably be operated at temperature range of about 350 to 800° F. Eutectic mixtures with melting points in the range of 150 to 600° F. and operating temperatures o in the range of about 350 to 8000 F are suitable.

It might be expected that magnesium carbonate would decompose at the process conditions. References to the temperature for decomposition vary widely. Many MSDS sheets list the decomposition temperature ate about 250° C. (482° F.). The online encyclopedia, Wikipedia at http://en.wikipedin.org/wikitMagnesium_carbonate lists the decomposition temperature at 540° C. (1004° F.) but also states that the decomposition temperature is in the range of 800-1000° C. (1472-1832° F.). It is therefore surprising that the suspended magnesium silicate does not decompose but instead forms stable magnesium carbonate at the temperatures of the invention, i.e. at 1500-2000° F.

Mineral magnesium silicate is fed from bin 101 (FIG. 3) to reactor vessel 101 through mixer 105 as needed to replace that being drawn off through conduit 110. Make-up salt for replacement of lost salt may also be added to the reactor vessel in the same manner. Gas containing CO₂ enters the reaction vessel through conduit 120 and through mixer 105. The gas travels down the inlet conduit 104 and discharged below the surface of the molten salt 112. When the CO₂ contacts magnesium silicate in the salt pool it is converted to MgCO₃, removing CO₂ from the gas stream and generating heat. The process is suitable for any CO₂ containing gases, including flue gases from fossil fuel power generation plants, synthesis gases from gasification processes, gases from fossil fuel fired boilers, natural gas containing CO₂, and the like.

As the gas flows through and out of the salt it forms froth on the surface. The gas, from which CO₂ has been removed, passes out of the reactor vessel 102 by conduit 121. Inside the reaction vessel is a sump ring 108 for removal of salt and minerals. The froth, 109, spills over into the sump ring together with salt and minerals and pass through conduit 110 into a water wash unit 103. The salt mixture is also removed from the reactor vessel by conduit 128 into the water wash vessel 123. In vessel 123 the salt mixture is mixed with water to remove the salt from the solids. The salt, soluble in water, is recycled as an aqueous solution to reactor vessel 102 through conduit 122.

Water insolubles from wash unit 103 that are removed through conduit a 124 will be predominately a mixture un-reacted magnesium silicate mineral and magnesium carbonate. This mixture is removed from vessel 103, through conduit 124, and optionally dried for disposed. Disposal presents no environmental problems since both magnesium silicate minerals and magnesium carbonate are common natural materials. These harmless compounds they may be disposed of in any expedient way as by use as landfill, used as component of concrete or even dumped at sea.

Alternatively the minerals may be separated and the recovered magnesium silicate mineral and/or product of the separation be reused in the CO₂ capture process.

Drain 125 is utilized to remove any metals or other heavy components of the salt from the reactor vessel.

### Example

The following test illustrates the efficacy of the gasifier reactor to achieve a high degree of gasification of powdered high sulfur coal.

### Test Results

A prototype reaction vessel consisting of a 11″×29″ inconel vessel fitted with a 6.5″×36″ stainless steel pre-gasifier tube that is notched on the bottom and extends to 2″ off the bottom of the vessel was used for these tests. The vessel was filled with 40 pounds of NaCl salt and 2 pounds of olivine. It was heated by external electric heaters to 1750° F. and created a depth of 10 inches molten bath. A coal slurry ground to an average of 50 microns was mixed with two parts water to make a pumpable slurry. The slurry was pumped into the reactor at a flow rate of 3 ounces per minute. After ten minutes a sample of the outlet gas was collected and sent to a commercial lab for analysis. They reported:

### H₂₋—99.8%

### CO—0%,

### CO₂—0%

### Sulfur—0%.

Several repetitive tests were run with duplicate results.

Another test was run with no olivine in the salt bath and the results were:

### H₂—77%

### CO₂—17%.

This shows that CO₂ would be available for enhanced oil recovery or other purposes if desired.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A process for producing hydrogen from a carbon containing fuel comprising;
contacting fuel, water and oxygen in a pre-reactor at an elevated temperature, to convert some of the carbon in the fossil fuel to hydrogen and carbon monoxide;
discharging effluent gas and solids from the pre-reactor below the surface of a molten salt under such conditions of residence time and temperature that carbon from the fossil fuel in the pre-reactor effluent is converted to hydrogen and carbon monoxide, and carbon monoxide is converted to carbon dioxide

2. The process of claim 1 wherein carbon dioxide produced is reacted with a magnesium silicate mineral suspended in the molten salt.

3. The process of claim 1 wherein the molten salt is selected from a group consisting of metal chlorides, carbonates, sulfates, sulfites, nitrates, nitrites, bromides, oxides, hydroxides, perchlorates, and mixtures thereof.

4. The process of claim 3 wherein the molten salt comprises sodium chloride.

5. The process of claim 1 wherein the salt pool is operated at a temperature between about 1500° F. and about 2000° F.

6. The process of claim 2 wherein the magnesium silicate is selected from a group of minerals comprising serpentine, enstatite, wollastonite, foresterite and olivine.

7. The process of claim 1 wherein the pressure in maintained at a pressure below four atmospheres.

8. The process of claim 2 wherein the molten salt is selected from a group consisting of metal chlorides, carbonates, sulfates, sulfites, nitrates, nitrites, bromides, oxides, hydroxides, perchlorates, and mixtures thereof and the process is operated at a temperature between about 1500° F. and about 2000° F.

9. A process for producing hydrogen from carbon containing fuel comprising;
contacting a fuel and water in a pre-reactor at a temperature of from between 1500° F. and 2000° F. to convert some of the carbon in the fuel to hydrogen and carbon monoxide and discharging effluent gas and solids from the pre-reactor below the surface of a molten salt pool under such conditions of residence time and temperature that some of the carbon from the fuel in the pre-reactor effluent is converted to carbon dioxide, which, in turn, is reacted with mineral magnesium silicate suspended in the molten salt.

10. The process of claim 9 wherein the molten salt comprises sodium chloride.

11. The process of claim 9 wherein the molten salt is externally heated and the mineral magnesium silicate is selected from a group of minerals comprising serpentine, enstatite, wollastonite, foresterite and olivine.

12. The process of claim 9 wherein the pre-reactor is a tube disposed inside a vessel that contains the molten salt pool.

13. The process of claim 9 wherein the water is in excess of that needed to complete the water gas reaction of all reacted carbon.

14. A process for capturing carbon dioxide from a gas stream comprising contacting a gas stream containing carbon dioxide with a mineral magnesium silicate compound suspended in a molten salt and recovering a mixture comprising magnesium carbonate.

15. The process of claim 14 wherein the molten salt is selected from a group consisting of metal chlorides, carbonates, sulfates, sulfites, nitrates, nitrites, bromides, oxides, hydroxides, perchlorates, and mixtures thereof and the magnesium silicate is selected from a group of minerals comprising serpentine, enstatite, wollastonite, foresterite and olivine.

16. The process of claim 14 wherein the salt pool is maintained at a temperature between about 1500° F. and about 2000° F.

17. The process of claim 14 wherein the molten salt pool comprises sodium chloride.

18. The process of claim 14 wherein the molten salt comprises a eutectic mixture of salts having a melting point between about 150 and 600° F. and wherein the salt is maintained in a temperature range of about 350 to 800° F.
